(19) United States
(12) Patent Application Publication
(10) Pub. No.: US 2009/0086825 A1
(43) Pub. Date: Apr. 2, 2009

(54) METHOD AND APPARATUS FOR TRANSMITTING AND RECEIVING BROADCAST DATA FOR DIGITAL BROADCAST SYSTEM

(75) Inventor: Boo Sup JUNG, Cheonan-si (KR)

Correspondence Address: Jefferson IP Law, LLP, 1730 M Street, NW, Suite 807, Washington, DC, 20036, US

(73) Assignee: SAMSUNG ELECTRONICS CO. LTD., Suwon-si (KR)

(21) Appl. No.: 12/236,702

(22) Filed: Sep. 24, 2008

(30) Foreign Application Priority Data
Oct. 1, 2007 (KR) 2007-0098800

(51) Int. Cl. H04N 7/24

(52) U.S. Cl. 375/240.26; 375/E07.015

(57) ABSTRACT

A method and apparatus for transmitting and receiving broadcast data in a digital broadcast system is provided. The method includes broadcasting, at a broadcast station, a broadcast signal on a corresponding service channel according to a time slicing technique using at least two streams, receiving, at a broadcast receiver, the broadcast signal from the corresponding service channel according to the time slicing technique from the at least two streams, determining a channel status based on the received broadcast signal, and demodulating the broadcast signal received on at least one of the at least two streams according to the channel status.

### PRIORITY

This application claims the benefit under 35 U.S.C. §119(a) of a Korean patent application filed in the Korean Intellectual Property Office on Oct. 1, 2007 and assigned Serial No. 2007-0098800, the entire disclosure of which is hereby incorporated by reference.

### BACKGROUND OF THE INVENTION

1. Field of the Invention

The present invention relates to a digital broadcast system. More particularly, the present invention relates to a method and apparatus for transmitting and receiving broadcast data in a digital broadcast system.

2. Description of the Related Art

A digital broadcast receiver is an apparatus that restores original digital data from a broadcast signal transmitted by a broadcast station. The digital data is coded and modulated to be broadcasted in the form of a broadcast signal by the broadcast station. The digital broadcast receiver demodulates and decodes the broadcast signal for restoring the original digital data. Accordingly, the digital broadcast receiver is provided with a tuner, a demodulator, and a decoder. Exemplary digital broadcast systems include a Digital Multimedia Broadcast (DMB) system and a Digital Video Broadcasting (DVB) system including a DVB-Terrestrial (DVB-T) system and DVB-Handheld (DVB-H) system.

Among the above identified exemplary digital broadcast systems, DVB-H is featured with a time slicing technique, error correction code, and IP datacast. More particularly, the time slicing technique enables power consumption of the DVB-H receiver to be reduced, because the DVB-H receiver is turned off when no data is being received. That is, the DVB-H receiver synchronizes to periodical bursts such that it switches to a power-save mode between the bursts.

FIG. 1 is a diagram illustrating a conventional time slicing technique.

In FIG. 1, a time-multiplexed DVB-H stream is illustrated as an example. In this example, 5 service channels (CH1 to CH5) are time-division multiplexed within a physical channel and the service channel CH3 is selected by a user.

The 5 service channels are transmitted with a cycle of delta-T, the DVB-H receiver powers on to receive the bursts of service channel CH3 and powers off between the bursts.

When using the time slicing technique, the receiver is activated for only a fraction of the time while receiving bursts of a requested service channel, thereby reducing power consumption.

However, there is room for further reduction of the power consumption of the time-multiplexing feature of the time slicing technique.

### SUMMARY OF THE INVENTION

An aspect of the present invention is to provide a method and apparatus for transmitting and receiving broadcast data in a digital broadcast system that is capable of improving power saving performance of a broadcast receiver by using an improved time slicing technique with an enhanced hierarchical modulation.

In accordance with an aspect of the present invention, a broadcast signal transmitting/receiving method for a digital broadcast system using a time slicing technique is provided. The method includes broadcasting, at a broadcast station, a broadcast signal on a corresponding service channel according to a time slicing technique using at least two streams, receiving, at a broadcast receiver, the broadcast signal from the corresponding service channel according to the time slicing technique from the at least two streams, determining a channel status based on the received broadcast signal, and demodulating the broadcast signal received on at least one of the at least two streams according to the channel status.

The broadcasting of the broadcast signal may include modulating the at least two streams to carry the broadcast signal of the corresponding service channel, and further wherein the broadcast signal is continuous in a same burst duration.

The channel status may be a carrier to noise ratio (c/n), and the demodulating of the broadcast signal may include demodulating the broadcast signal from all of the streams when the c/n is greater than a threshold value, and demodulating the broadcast signal from one of the streams when the c/n is equal to or less than the threshold value.

The broadcast signal transmitting/receiving method may further include extracting a burst interval of the service channel corresponding to the broadcast signal, calculating an off-time based on the burst interval and a number of the streams from which the broadcast signal is demodulated, and powering off at least a part of the broadcast receiver during the off-time.

The broadcast station may broadcast a plurality of broadcast signals on corresponding service channels according to the time slicing technique using the at least two streams.

The broadcast signal broadcast by the broadcast station may be modulated in at least one of Quadrature Phase Shift Keying (QPSK), 16 Quadrature Amplitude Modulation (16 QAM), and 64 QAM.

In accordance with another aspect of the present invention, a broadcast signal reception method for a digital broadcast system which transmits broadcast signals on corresponding service channels according to a time slicing technique using a plurality of modulation streams is provided. The method includes receiving a broadcast signal from a corresponding service channel according to a time slicing technique from a plurality of modulation streams, determining a channel status of the corresponding service channel, and demodulating the broadcast signal from at least one of the plurality of modulation streams according to the channel status.

The plurality of modulation streams may carry the broadcast signal of the corresponding service channel, and the broadcast signal may be continuous in a same burst duration.

The channel status may be a carrier to noise ratio (c/n), and the demodulating the broadcast signal may includes demodulating the broadcast signals from all of the plurality of modulation streams when the c/n is greater than a threshold value and demodulating the broadcast signals from one of the plurality of modulation streams when the c/n is equal to or less than the threshold value.

The broadcast reception method may further include extracting a burst interval of the service channel corresponding to the broadcast signal, calculating an off-time based on the burst interval and a number of the plurality of modulation streams from which the broadcast signal is demodulated, and powering off at least a part of a broadcast receiver during the off-time.

The broadcast signal from the plurality of modulation streams may be modulated in at least one of Quadrature Phase Shift Keying (QPSK), 16 Quadrature Amplitude Modulation (16 QAM), and 64 QAM.

The broadcast signal may be demodulated using Quadrature Phase Shift Keying (QPSK).

In accordance with another aspect of the present invention, a broadcast reception apparatus for a digital broadcast system which transmits broadcast signals of multiple service channels according to a time slicing technique on at least two modulation streams is provided. The apparatus includes a broadcast receiver for receiving a broadcast signal in bursts of a corresponding service channel from at least two modulation streams, and a controller for demodulating the broadcast signal from at least one of the at least two modulation streams according to a channel status of the service channel.

The at least two modulation streams may carry the broadcast signal of the corresponding service channel, and the broadcast signal may be continuous in a same burst duration.

The channel status may be a carrier to noise ratio (c/n), and the controller demodulates the broadcast signal from all of the at least two modulation streams when the c/n is greater than a threshold value and demodulates the broadcast signal from one of the at least two modulation streams when the c/n is equal to or less than the threshold value.

The control units may extract a burst interval of the corresponding service channel, calculates an off-time based on the burst interval and a number of the at least two modulation streams from which the broadcast signal is demodulated, and powers off at least a part of the broadcast receiver during the off-time.

The broadcast signal from the at least two modulation streams may be modulated in at least one of Quadrature Phase Shift Keying (QPSK), 16 Quadrature Amplitude Modulation (16 QAM), and 64 QAM.

The control unit may demodulate the broadcast signal using Quadrature Phase Shift Keying (QPSK).

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following detailed description in conjunction with the accompanying drawings, in which:

FIG. 1 is a diagram illustrating a conventional time slicing technique;

FIG. 2 is a diagram illustrating a time slicing technique of a digital broadcast method according to an exemplary embodiment of the present invention;

FIG. 3 is a schematic diagram illustrating a digital broadcast system according to an exemplary embodiment of the present invention;

FIG. 4A is a diagram illustrating a constellation of a Quadrature Phase Shift Keying (QPSK) modulation scheme according to an exemplary embodiment of the present invention;

FIG. 4B is a diagram illustrating a constellation of a 16 Quadrature Amplitude Modulation (16 QAM) scheme according to an exemplary embodiment of the present invention;

FIG. 4C is a diagram illustrating a constellation of a 64 QAM scheme according to an exemplary embodiment of the present invention;

FIG. 5 is a diagram illustrating a channel structure for transmitting a service in a digital broadcast system according to an exemplary embodiment of the present invention;

FIGS. 6A and 6B are diagrams illustrating channel structures for transmitting multiple services in a digital broadcast system according to an exemplary embodiment of the present invention;

FIG. 7 is a block diagram illustrating a configuration of a mobile terminal according to an exemplary embodiment of the present invention; and

FIG. 8 is a flowchart illustrating a broadcast reception method according to an exemplary embodiment of the present invention.

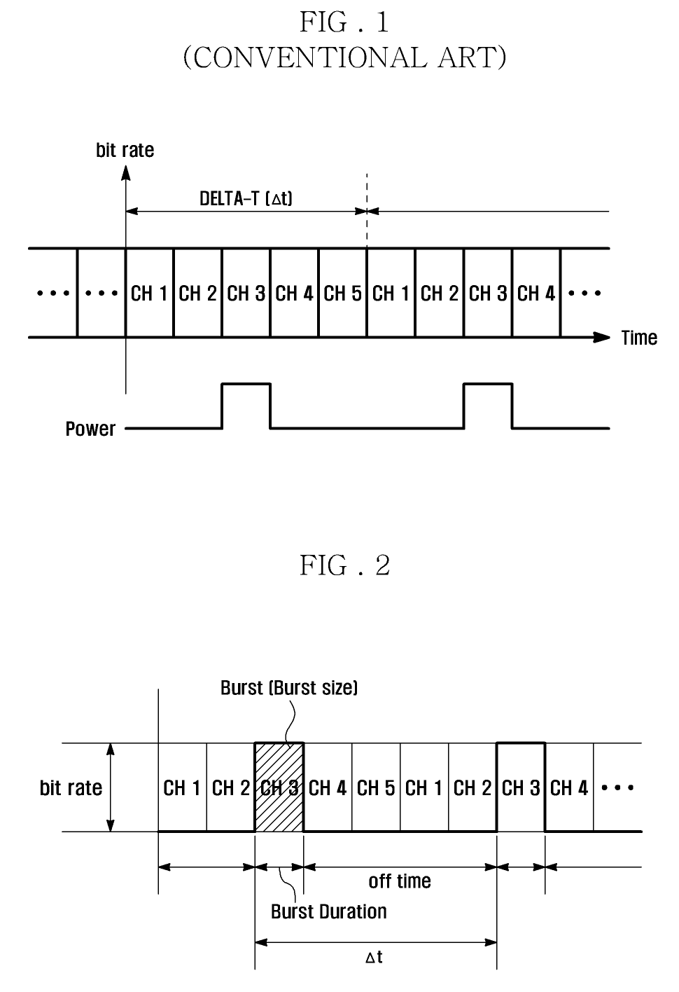

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and phrases used in the specification and appended claims are provided to enable a clear and consistent understanding of the detailed description and the claims. Unless otherwise noted, the terms and phrases are to be understood according to conventional usage by those skilled in the relevant art.

The digital broadcast receiver can be implemented in the form of a dedicated broadcast receiver or a mobile terminal equipped with a broadcast receiver module. The mobile terminal can be any of a mobile phone, a Personal Digital Assistant (PDA), a Smartphone, a 3^{rd} generation (3G) mobile terminal based on one of Wideband Code Division Multiple Access (WCDMA) and CDMA2000 technologies, a Global System for Mobile Communication (GSM) terminal, a General Packet Radio system (GPRS) terminal, and their equivalent information processing and multimedia devices. In the following description, exemplary embodiments of the present invention are described in association with a mobile terminal representing any of the above and other broadcast-enabled devices.

Although the digital broadcast method is described using a DVB-H system as an example, the present invention is not limited thereto. For example, the digital broadcast method can be applied to other types of broadcast systems using a hierarchical modulation.

The following definitions are provided to enable a clear and consistent understanding of the detailed description and the claims.

The term “broadcast signal” represents a broadcast program that is coded and modulated for transmission over the air. The broadcast signal may alternatively be referred to as a transport stream.

The term “channel” denotes a frequency channel to which a tuner is tuned, and “service” denotes one of time-division multiplexed channels on which a broadcast station transmits a broadcast program identified with a program identifier or product identifier.

In order to assist with understanding of exemplary embodiments of the present invention, the channel to which the tuner is tuned is referred to as “physical channel”, and the service selected on a physical channel is referred to as “service channel”. In the DVB-H system, multiple service channels are transmitted on the same physical channel. The service channel is identified by Program IDentifiers (PIDs) in the DMB system and the DVB-T system. In the case of the DVB-H system, the service channel is identified with a combination of a PID, an IP address, and a port number.

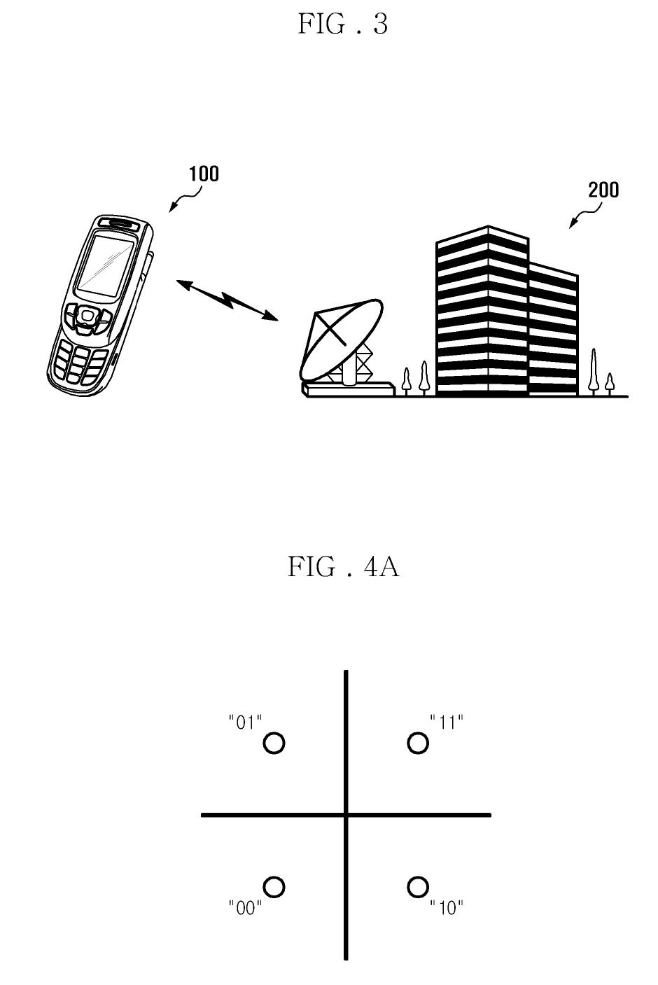

FIG. 2 is a diagram illustrating a time slicing technique of a digital broadcast method according to an exemplary embodiment of the present invention.

Referring to FIG. 2, a DVB-H broadcast station broadcasts a plurality of service channels that are time-division multiplexed on a given frequency channel. The data representing a particular service is received in bursts. To inform the broadcast receiver when to expect the next burst of a given service channel, the time delta-T (Δt) to the beginning of the next burst of the given service channel is included within the burst of the given service channel currently being received. The number of network layer bits within a time sliced burst is referred to as “Burst Size”, and the time fraction assigned to a service channel in the delta-T is referred to as “Burst Duration”.

When the broadcast receiver is set for a particular service, the broadcast receiver switches on during the burst duration of the service. The time between the bursts is referred to as “off-time”. In the following description, it is assumed that the channel is ideal such that jitter of delta-T is ignored. The bitrate while transmitting a burst is referred to as a “Burst Bitrate”. The Burst Size can be determined by multiplying the Burst Size with the Burst Bitrate.

In order to maximize the power saving effect of the time slicing, hierarchical modulation and network-adaptive delta-T adjustment techniques are used.

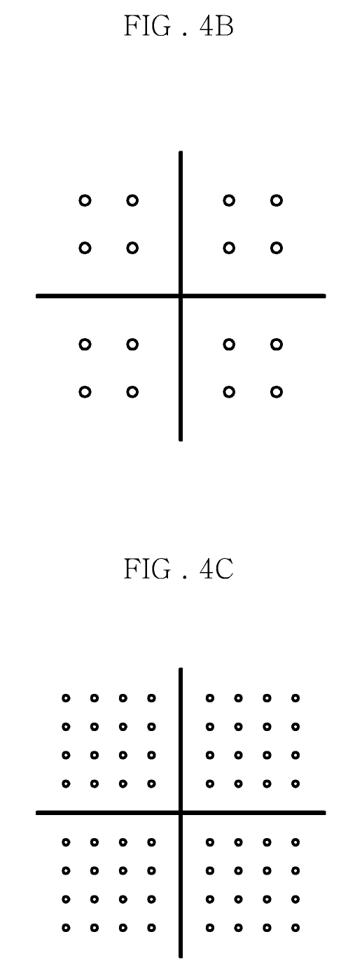

FIG. 3 is a schematic diagram illustrating a digital broadcast system according to an exemplary embodiment of the present invention.

Referring to FIG. 3, the digital broadcast system includes a mobile terminal 100 and a broadcast station 200.

The broadcast station 200 multiplexes and modulates a plurality of service channels and then broadcasts the service channels. The service channels can be transmitted together with MultiProtocol Encapsulation Forward Error Correction (MPE-FEC) sections. The broadcast station modulates the broadcast signals using a hierarchical modulation scheme.

The use of hierarchical modulation can increase the off-time while maintaining burst intervals. In other words, the use of hierarchical modulation allows for the transmission of more data in a given time interval by increasing the bit rate.

The mobile terminal 100 receives the broadcast signals with different delta-Ts while maintaining the burst duration according to a value of a carrier to noise ratio (c/n). In a case of receiving the broadcast signal with an increased delta-T, the off-time increases, which results in an improvement of the power saving effect.

The adoption of the hierarchical modulation to the time slicing technique is described hereinafter.

Hierarchical modulation allows the broadcast station 200 to transmit two different streams. In this exemplary embodiment, a single DVB-H stream carries two separate transport streams, a High Priority (HP) stream and a Low Priority (LP) stream.

In more detail, the broadcast station 200 transmits the HP stream with broadcast signals for standard resolution content and the LP stream with broadcast signals for high resolution content. The mobile terminal 100 can receive one of the transport streams according to its capability.

Although it is described that the HP and LP streams carry the same content having different resolutions, they can be configured to carry the contiguous broadcast data of the same content. More particularly, the broadcast station 200 can broadcast a service channel in a multi-transport stream structure using the hierarchical modulation technique.

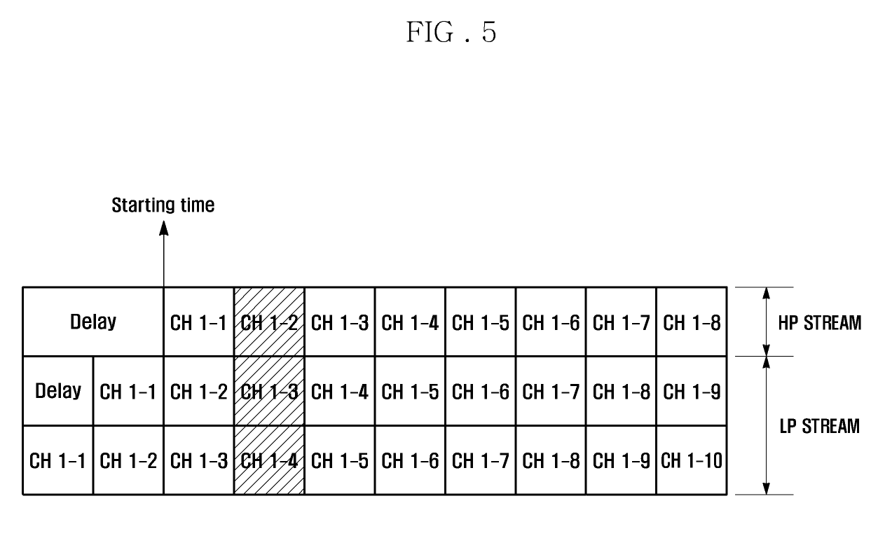

FIG. 4A is a diagram illustrating a constellation of a Quadrature Phase Shift Keying (QPSK) modulation scheme according to an exemplary embodiment of the present invention.

Referring to FIG. 4A, a QPSK scheme uses four points on the constellation diagram, equispaced around a circle. With four phases, QPSK can encode two bits per symbol. The constellation bit assignments are done such that any two adjacent constellation points differ by only one bit to help reduce the number of bit errors made in the event of a received symbol error. That is, in the QPSK scheme, pairs of bits 00, 01, 10, and 11 are mapped to four quadrants of the signal space.

Since each symbol is mapped to a signal quadrant, QPSK is robust to phase errors. The QPSK scheme is advantageous for transmitting data with accuracy and is therefore suitable for mobile communication terminals.

FIG. 4B is a diagram illustrating a constellation of a 16 Quadrature Amplitude Modulation (16 QAM) scheme according to an exemplary embodiment of the present invention.

Referring to FIG. 4B, 4 constellation points, i.e. symbols, occupy each quadrant. In the 16 QAM, the error of a symbol can be corrected in consideration of a relationship with other symbols in the same quadrant. That is, in 16 QAM, four bits are assigned to a symbol such that 16 symbols (i.e., 0000, 0001, 0010, . . . , 0111, and 1111) are mapped to the 16 constellation points, 4 per quadrant. 16 QAM can correspond to two QPSK constellations by decomposing the bits allocated to each symbol. That is, a 16 QAM symbol composed of 4 bits can be decomposed into first half two bits and last half two bits. Since the four symbols are positioned in each quadrant, 16 QAM provides a higher data rate than QPSK, whereas it has higher signal distortion probability. Accordingly, 16 QAM is preferably used in a wireless network having good channel conditions or in wired networks.

FIG. 4C is a diagram illustrating a constellation of a 64 QAM scheme according to an exemplary embodiment of the present invention.

Referring to FIG. 4C, 16 constellation points occupy each quadrant. Accordingly, when a symbol error is detected, the error correction is performed in consideration of a relationship with at least 2 to 8 symbols positioned in the same quadrant. The 64 QAM symbols can be expressed as 000000, 000001, 000010, . . . , 111111.

The 64 QAM scheme can be represented by 3 QPSK constellations. That is, 6 bits constituting each 64 QAM symbol can be decomposed into 3 two-bit symbols and each two-bit symbol corresponds to a QPSK symbol.

Since the 64 QAM symbol is too long in bit-length, it is vulnerable to error. Accordingly, it can be used in a highly reliable wireless communication environment and a wired communication network.

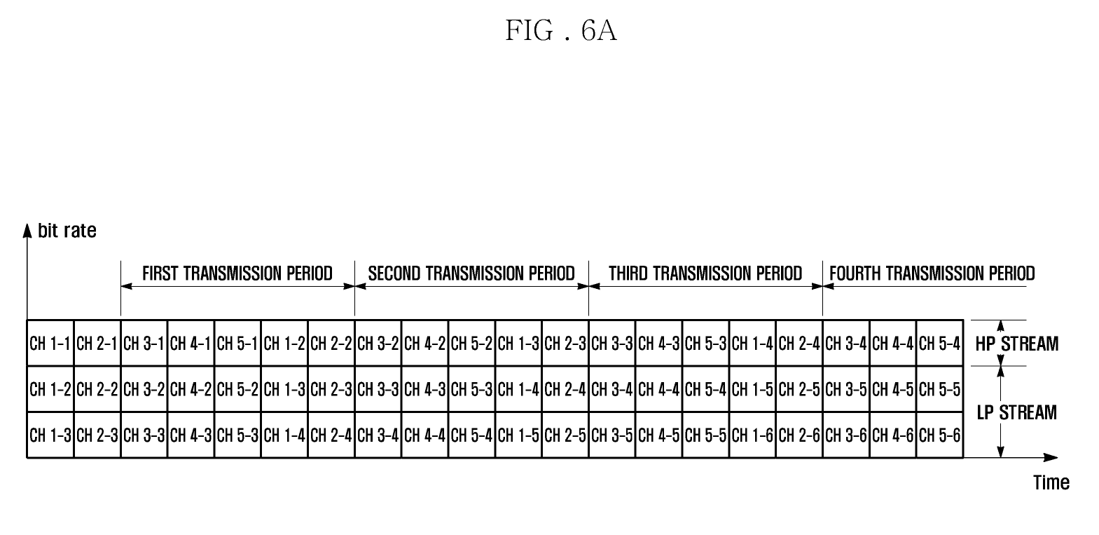

FIG. 5 is a diagram illustrating a channel structure for transmitting a service in a digital broadcast system according to an exemplary embodiment of the present invention. In this embodiment, a 64 QAM scheme is used for modulating the broadcast signal.

Referring to FIG. 5, a plurality of continuous packets carrying the broadcast data of a specific service channel is transmitted in the form of three packet streams. Here, the packets can be IPv4 or IPv6 packets.

The service channel CH1 is composed of a plurality of continuous packets (CH1-1, CH1-2, Ch1-3, CH1-4, CH1-5, . . . ) and is transmitted in the form of 3 packet streams (first to third streams). Since a 64 QAM symbol carries 6 bits of information, it can be decomposed into 3 parts coded in a QPSK scheme according to an exemplary embodiment of the present invention.

The first stream is mapped to the High Priority (HP) stream, and the second and third streams are mapped to the Low Priority (LP) stream.

The first stream is transmitted in a sequential order of packets. The second stream is transmitted with delay by one burst duration relative to the first stream, and the third stream is transmitted with delay by two burst durations relative to the first stream.

Since the second stream is transmitted with a delay time of 1 burst duration relative to the first stream and the third stream of 1 burst duration relative to the second stream, the first to third streams carry the continuous packets at the same burst duration. For example, the packets CH1-1, CH1-2, and CH1-3 are transmitted through the respective first, second, and third streams in the same burst duration. In the same manner, the next burst duration carries the CH1-2, CH1-3, and CH1-4 on the first to third streams.

In a case of using a 16 QAM scheme, two streams can be transmitted, the first stream mapped to the HP stream and the second stream mapped to the LP stream. Accordingly, two continuous packets, e.g. CH1-1 and CH1-2, are delivered in a single burst duration.

In a real world broadcast system, a plurality of service channels are transmitted during the delta-T. The transmission of multiple service channels is described hereinafter.

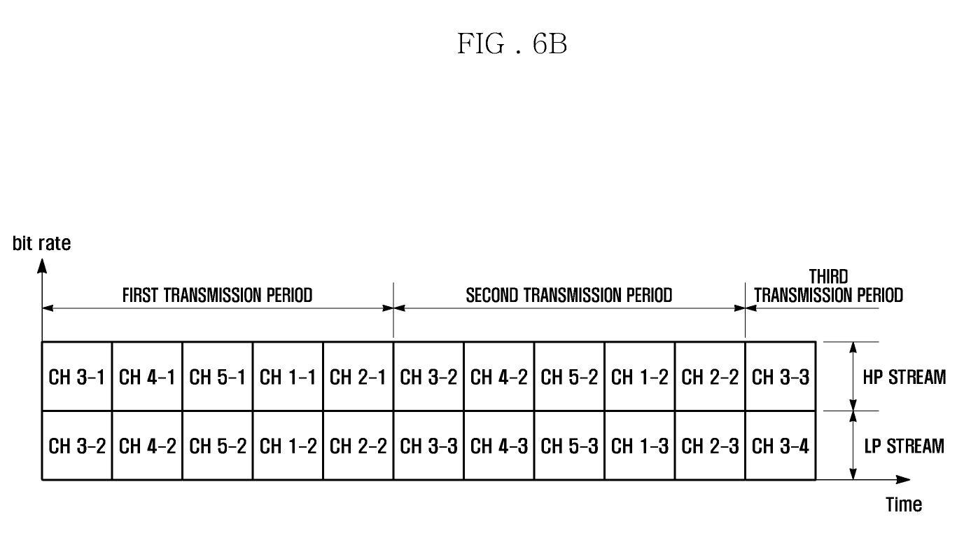

FIGS. 6A and 6B are diagrams illustrating channel structures for transmitting multiple services in a digital broadcast system according to an exemplary embodiment of the present invention. FIG. 6A shows a channel structure when using 64 QAM, and FIG. 6B shows a channel structure when using 16 QAM. In an exemplary embodiment of the present invention, 5 service channels are transmitted on a physical channel.

Referring to FIG. 6A, the broadcast station 200 transmits 5 service channels over two broadcast streams, the HP and LP streams. The broadcast station 200 transmits the broadcast data in the form of 3 QPSK symbols represented by a 64 QAM modulation symbol.

The broadcast station 200 transmits the data of a specific channel in bursts such that the CH3-1 carried by the HP stream and the CH3-2 and CH3-3 carried by the LP stream are transmitted in the same burst duration. In FIG. 6A, the continuous packets CH3-1, CH3-2, and CH3-3 are simultaneously transmitted in the burst of the service channel CH3 during the first transmission period. That is, the packet carried by the HP stream is simultaneously transmitted together with two continuous packets carried by the LP stream. In the meantime, the packet CH3-4 following the packet CH3-3 is transmitted in the HP stream during the fourth transmission period together with the packets CH3-5 and CH3-6 transmitted in the LP stream.

In this case, if the mobile terminal 100 is configured to demodulate the HP and LP streams, the mobile terminal 100 can receive the first to third packets in the first transmission period and the fourth packet after skipping two transmission periods, i.e. in the fourth transmission period.

In addition, the broadcast station 200 transmits the data on the HP stream in a sequential order such that three continuous packets are delivered in the burst durations of the continuous transmission periods. For example, the packets CH3-1, CH3-2, and CH3-3 of the channel CH3 are carried by the HP stream in the bursts of the first to third transmission periods. Accordingly, the mobile terminal configured to demodulate only the HP stream can receive the data in the sequential transmission period order.

In FIG. 6B, the broadcast station 200 transmits the data of 5 service channels on two streams: HP and LP streams. The broadcast station transmits the data in the form of 3 QPSK symbol represented by a 16 QAM modulation symbol.

As shown in FIG. 6B, two continuous packets of a specific service channel are simultaneously transmitted in a burst duration. For example, the first and second packets CH3-1 and CH3-2 of the service channel CH3 are carried by the respective HP and LP streams in the same burst duration of the first transmission period, and the third and fourth packets CH3-3 and CH3-4 are transmitted in the respective HP and LP streams during the third transmission period.

Accordingly, when the mobile terminal 100 is configured to demodulate both the HP and LP streams, the mobile terminal 100 can receive the first and second packets in the first transmission period and the third packet after skipping one transmission period, i.e. in the third transmission period.

In addition, the broadcast station 200 transmits the data on the HP stream in a sequential order such that the packets are delivered in continuous transmission periods. For example, the packets CH3-1, CH3-2, and CH3-3 of the channel CH3 are carried by the HP stream in the bursts of the first to third transmission periods. Accordingly, the mobile terminal configured to demodulate only the HP stream can receive the data in the sequential transmission period order.

As described above, the digital broadcast method allows continuous data units of a specific service to be simultaneously carried by at least two different data streams to increase an off-time between two burst reception times. For example, the broadcast station 200 can transmit the packet CH3-1 carried by the HP stream and the packet CH3-2 carried by the LP stream at the CH3 burst of a first transmission period and the packets CH3-2 of the HP stream and CH4 of the LP stream at the CH3 burst of the third transmission period, whereby the mobile terminal 100 configured to demodulate the HP and LP streams can skip receipt of the CH burst of the second transmission period.

In the meantime, the broadcast station 200 also transmits the data units of each service channel on the HP stream in a sequential order. For example, the broadcast station 200 transmits the packets CH3-1, CH3-2, and CH3-3 in the bursts of the respective first to third transmission periods on the HP stream, such that the mobile terminal configured to modulate only the HP stream can receive the packets CH3-1, CH3-2, and CH3-3 one by one.

As described above, the mobile terminal having the capability to demodulate the HP and LP streams transmitted in the above manner can operate with an extended off-time, resulting in an improvement of power conservation performance.

Although the broadcast method is described in association with QPSK, 16 QAM, and 64 QAM, the present invention is not limited thereto. The present invention is equally applicable to various other modulation schemes that can be used in a hierarchical modulation technique.

Now the structure and operation of a mobile terminal configured to demodulate the broadcast signal transmitted in the above-described broadcast method is described hereinafter.

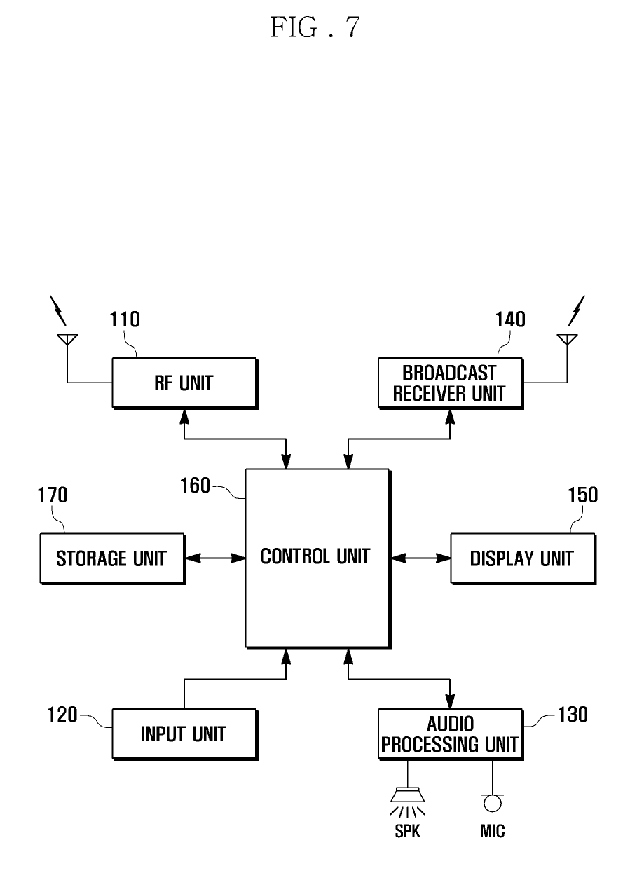

FIG. 7 is a block diagram illustrating a configuration of a mobile terminal according to an exemplary embodiment of the present invention.

Referring to FIG. 7, the mobile terminal 100 includes a Radio Frequency (RF) unit 110, an input unit 120, an audio processing unit 130, a broadcast receiver unit 140, a display unit 150, a control unit 160, and a storage unit 170.

The RF unit 110 is responsible for radio communication of the mobile terminal 100 under the control of the control unit 160. The RF unit 110 includes an RF transmitter for up-converting and amplifying signals to be transmitted and an RF receiver for low noise amplifying and down-converting radio signals received through an antenna.

The input unit 120 is provided with a plurality of alphanumeric keys for inputting alphanumeric data and function keys for configuring and executing various functions of the mobile terminal 100. The function keys may include navigation keys, side keys, and shortcut keys. The input unit 120 also generates key sequences corresponding to user's key input and transmits the key sequences to the control unit 160. The input unit 120 may be configured to generate commands for controlling the broadcast function and transmits the commands to the control unit 160. The input unit 120 may be implemented in whole or in part as a touchscreen that provides an interface by which a user can input commands or information to the mobile terminal 100 by touching icons being displayed on the screen using the user's finger and/or a stylus pen. When input unit 120 is implemented in whole or in part as a touchscreen, the touchscreen may also serve as all or part of display unit 150.

The audio processing unit 130 is provided with a speaker (SPK) for outputting the audio signal extracted from the received broadcast signal and a microphone (MIC) for inputting audio signal including voice.

The broadcast receiver unit 140 receives the broadcast signal of a specific service channel on a physical channel. The broadcast receiver unit 140 includes a tuner which is tuned to a frequency channel and a channel filter for filtering the service channel on the frequency channel. More particularly, in this exemplary embodiment of the present invention, the broadcast receiver unit 140 is configured to turn on at burst times of the selected service channel and turn off between the bursts.

The broadcast receiver unit 140 further includes a receiver for receiving the broadcast signals and a timing and synchronization module for receiving a specific channel in association with the time slicing technique.

The display unit 150 displays various screen images associated with the operation of the mobile terminal 100. More particularly, the display unit 150 displays the video data extracted from the broadcast signals in the form of a visual image.

The storage unit 170 stores application programs associated with various functions of the mobile terminal 100, including the application program for controlling receipt and playback of the broadcast signals. The storage unit 170 is configured to buffer and store the application and user data under the control of the control unit 160.

More particularly, the storage unit 170 may be provided with a buffer for buffering the broadcast signals when the mobile terminal 100 operates in the broadcast reception mode. The size of the buffer must be larger than the burst size. However, the buffer size can be configured to buffer the bursts of the service channels in a transmission period.

The control unit 160 controls the operations of the internal units of the mobile terminal 100. More particularly, the control unit 160 may control the broadcast receiver unit 140 to select one of time sliced bursts in response to a service channel selection command input though the input unit 120. That is, the control unit 160 controls such that the broadcast receiver unit 140 powers on at the burst times of the selected service channel.

The control unit 160 also controls the broadcast receiver unit 140 to modulate the broadcast signal in a single stream demodulation mode or a multi-stream demodulation mode according to the channel condition.

The channel condition is determined on the basis of a carrier to noise ratio (c/n). The broadcast signal carries the HP and LP streams. The broadcast receiver unit 140 performs modulation on the HP stream in the single stream demodulation mode and on HP and LP streams in the multi-stream demodulation mode.

In more detail, the control unit 10 controls broadcast receiver unit 140 to modulate the broadcast signal in the multi-stream demodulation mode when the c/n is greater than a threshold value and in the single stream demodulation mode when the c/n is equal to or less than the threshold value.

The threshold value can be determined on the basis of a result of a simulation performed by the manufacturer. For instance, in an environment in which the guide interval is ¼, a number of carriers is 4 K, a code rate is ⅔, the broadcast receiver unit 140 operates in a multi-stream demodulation mode when the c/n is greater than 27 dB and in a single stream demodulation mode when the c/n is equal to or less than 27 dB.

The analog broadcast signal and digital broadcast signal are inversely proportional to the Quality of Service (QoS) and the c/n. However, unlike the analog broadcast signal, the QoS of the digital broadcast signal decreases in the form of a step function, but not gradually. Accordingly, it is preferred that the threshold value is determined on the basis of a result of a simulation.

The control unit 160 may include a modulation module that is capable of processing the broadcast signal modulated in various modulation schemes used by the broadcast station 200. In the case that the broadcast station 200 uses the QPSK, 16 QAM, and 64 QAM, the control unit 160 of the mobile terminal 100 demodulates the received broadcast signal in the QPSK, 16 QAM, and 64 QAM modulation schemes. The control unit 160 also separates audio and video streams and broadcast information from the demodulated broadcast signal.

The broadcast reception method of the above structured mobile terminal is described hereinafter.

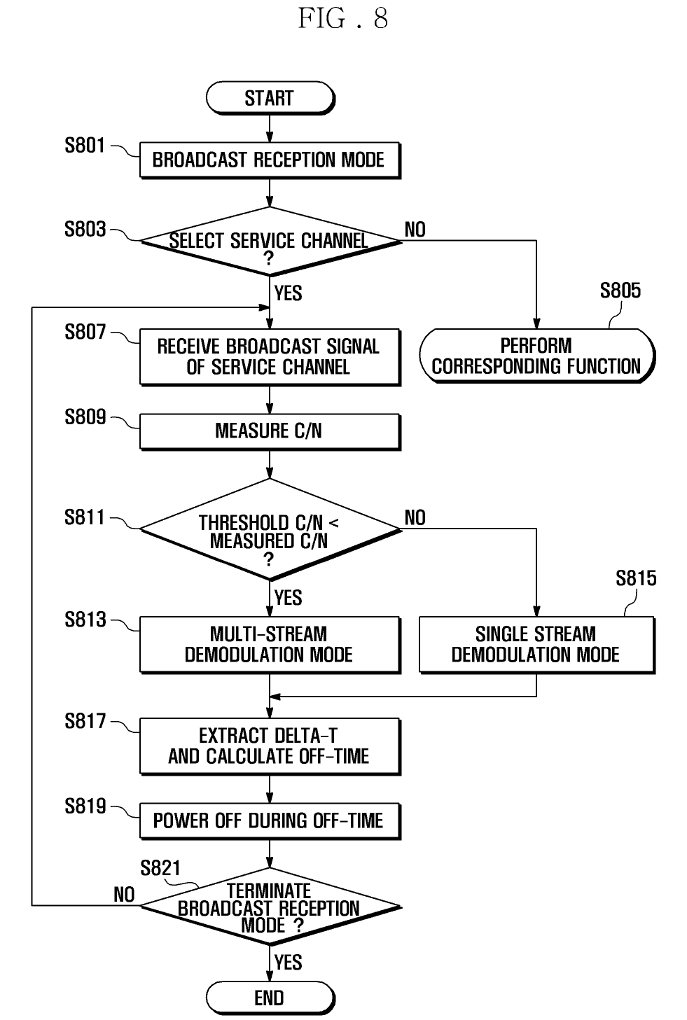

FIG. 8 is a flowchart illustrating a broadcast reception method according to an exemplary embodiment of the present invention.

Referring to FIG. 8, the mobile terminal 100 operates in a broadcast reception mode in step S801. During the operation in the broadcast reception mode, the control unit 160 of the mobile terminal 100 monitors to detect a user command input through the input unit 120 and determines whether the user command is a service channel selection command in step S803. If the user command is not a service channel selection command, the control unit 160 performs a corresponding function in step S805.

If the user command is a service channel selection command, the control unit 160 controls the broadcast receiver unit 140 to power on at the bursts of the selected service channel to receive the broadcast signal in step S807.

While receiving the broadcast signal on the selected service channel, the control unit 160 measures the c/n in step S809 and determines whether the measured c/n is greater than a c/n threshold in step S811. If the measured c/n is greater than the c/n threshold, the control unit 160 processes the broadcast signal in a multi-stream demodulation mode in step S813 and, otherwise, processes the broadcast signal in a signal stream modulation in step S815.

The broadcast receiver unit 140 demodulates the HP and LP streams of the broadcast signal in the multi-stream demodulation mode and demodulates only the HP stream in the single stream demodulation mode.

Next, the control unit 160 extracts the delta-T information from the broadcast signal and calculates the off-time on the basis of the delta-T information in step S817.

After calculating the off-time, the control unit 160 controls at least a portion of the broadcast receiver unit 140 to power off during the off-time in step S819 and determines whether a broadcast reception mode termination command is detected in step S821.

If a broadcast reception mode termination command is detected, the control unit 160 controls to end the broadcast reception mode and, otherwise, returns to step S807. At this time, the broadcast receiver unit 140 powers on at the next burst time after the off-time. In the case that the broadcast receiver unit 140 operates in the multi-stream demodulation mode, the off-time corresponds to 3 transmission periods, whereas the off-time is equal to 1 transmission period in the single stream demodulation mode.

Although the broadcast reception method is described in association with the QPSK, 16 QAM, and 64 QAM in exemplary embodiments herein, the present invention is not limited thereto. The broadcast reception method of the present invention can be applied to any of broadcast systems using a hierarchical modulation technique implemented with various modulation schemes.

While the present invention has been shown and described with reference to certain exemplary embodiments thereof, it will be understood by those skilled in the art that various changes in form and details may be made therein without departing from the spirit and scope of the present invention as defined by the appended claims and their equivalents.

As described above, the broadcast transmission and reception method and apparatus of exemplary embodiments of the present invention enable an increase of the off-time of a broadcast receiver while maintaining burst intervals of service channels, thereby resulting in a reduction of power consumption of the broadcast receiver.

What is claimed is:

1. A broadcast signal transmitting/receiving method for a digital broadcast system using a time slicing technique, the method comprising:
broadcasting, at a broadcast station, a broadcast signal on a corresponding service channel according to a time slicing technique using at least two streams;
receiving, at a broadcast receiver, the broadcast signal from the corresponding service channel according to the time slicing technique from the at least two streams;
determining a channel status based on the received broadcast signal; and
demodulating the broadcast signal received on at least one of the at least two streams according to the channel status.

2. The method of claim 1, wherein the broadcasting of the broadcast signal comprises modulating the at least two streams to carry the broadcast signal of the corresponding service channel, and further wherein the broadcast signal is continuous in a same burst duration.

3. The method of claim 1, wherein the channel status comprises a carrier to noise ratio (c/n), and further wherein the demodulating of the broadcast signal comprises demodulating the broadcast signal from all of the streams when the c/n is greater than a threshold value, and demodulating the broadcast signal from one of the streams when the c/n is equal to or less than the threshold value.

4. The method of claim 1, further comprising:
extracting a burst interval of the service channel corresponding to the broadcast signal;
calculating an off-time based on the burst interval and a number of the streams from which the broadcast signal is demodulated; and
powering off at least a part of the broadcast receiver during the off-time.

5. The method of claim 1, wherein the broadcast station broadcasts a plurality of broadcast signals on corresponding service channels according to the time slicing technique using the at least two streams.

6. The method of claim 1, wherein the broadcast signal broadcast by the broadcast station is modulated in at least one of Quadrature Phase Shift Keying (QPSK), 16 Quadrature Amplitude Modulation (16 QAM), and 64 QAM.

7. A broadcast signal reception method for a digital broadcast system which transmits broadcast signals on corresponding service channels according to a time slicing technique using a plurality of modulation streams, the method comprising:
receiving a broadcast signal from a corresponding service channel according to a time slicing technique from a plurality of modulation streams;
determining a channel status of the corresponding service channel; and
demodulating the broadcast signal from at least one of the plurality of modulation streams according to the channel status.

8. The method of claim 7, wherein the plurality of modulation streams carry the broadcast signal of the corresponding service channel, and further wherein the broadcast signal is continuous in a same burst duration.

9. The method of claim 7, wherein the channel status comprises a carrier to noise ratio (c/n), and further wherein the demodulating of the broadcast signal comprises demodulating the broadcast signals from all of the plurality of modulation streams when the c/n is greater than a threshold value and demodulating the broadcast signals from one of the plurality of modulation streams when the c/n is equal to or less than the threshold value.

10. The method of claim 7, further comprising:
extracting a burst interval of the service channel corresponding to the broadcast signal;
calculating an off-time based on the burst interval and a number of the plurality of modulation streams from which the broadcast signal is demodulated; and
powering off at least a part of a broadcast receiver during the off-time.

11. The method of claim 7, wherein the broadcast signal from the plurality of modulation streams is modulated in at least one of Quadrature Phase Shift Keying (QPSK), 16 Quadrature Amplitude Modulation (16 QAM), and 64 QAM.

12. The method of claim 7, wherein the broadcast signal is demodulated using Quadrature Phase Shift Keying (QPSK).

13. A broadcast reception apparatus for a digital broadcast system which transmits broadcast signals of multiple service channels according to a time slicing technique on at least two modulation streams, the apparatus comprises:
a broadcast receiver for receiving a broadcast signal in bursts of a corresponding service channel from at least two modulation streams; and
a controller for demodulating the broadcast signal from at least one of the at least two modulation streams according to a channel status of the service channel.

14. The apparatus of claim 13, wherein the at least two modulation streams carry the broadcast signal of the corresponding service channel, and further wherein the broadcast signal is continuous in a same burst duration.

15. The apparatus of claim 13, wherein the channel status comprises a carrier to noise ratio (c/n), and further wherein the controller demodulates the broadcast signal from all of the at least two modulation streams when the c/n is greater than a threshold value and demodulates the broadcast signal from one of the at least two modulation streams when the c/n is equal to or less than the threshold value.

16. The apparatus of claim 13, wherein the control units extracts a burst interval of the corresponding service channel, calculates an off-time based on the burst interval and a number of the at least two modulation streams from which the broadcast signal is demodulated, and powers off at least a part of the broadcast receiver during the off-time.

17. The apparatus of claim 13, wherein the broadcast signal from the at least two modulation streams is modulated in at least one of Quadrature Phase Shift Keying (QPSK), 16 Quadrature Amplitude Modulation (16 QAM), and 64 QAM.

18. The apparatus of claim 13, wherein the control unit demodulates the broadcast signal using Quadrature Phase Shift Keying (QPSK).
